(19) United States
(12) Patent Application Publication
(10) Pub. No.: US 2018/0134370 A1
(43) Pub. Date: May 17, 2018

(54) TREATED TAPERED ARTICLE AND METHOD OF TREATMENT FOR A TAPERED ARTICLE

(71) Applicant: ROLLS-ROYCE plc, London (GB)

(72) Inventors: Andre LIM, Singapore (SG); Sylvie J. CASTAGNE, Singapore (SG); Chow Cher WONG, Singapore (SG); Rajarshi MAITI, Singapore (SG); Abhay GOPINATH, Singapore (SG)

(73) Assignee: ROLLS-ROYCE plc, London (GB)

(21) Appl. No.: 15/801,556

(22) Filed: Nov. 2, 2017

(30) Foreign Application Priority Data
Nov. 11, 2016 (GB) 1619092.8

(51) Int. Cl. B64C 3/14; B21B 1/08; B64C 9/16; B64C 9/22

(52) U.S. Cl. CPC B64C 3/14; B21B 1/08; B64C 2003/147; B64C 9/22; B64C 2003/146; B64C 9/16

(57) ABSTRACT

There is disclosed a method of treating a metal article which tapers towards an edge. A compressive force is applied to a treatment region of the article to generate an edge region of compressive residual stress adjacent the edge, and the treatment region is spaced apart from the edge region by an intermediate region.

### CROSS-REFERENCE TO RELATED APPLICATION

This application is based upon and claims the benefit of priority from British Patent Application Number 1619092.8 filed 11 Nov. 2016, the entire contents of which are incorporated by reference.

### FIELD OF DISCLOSURE

The disclosure relates to a method of treating an article which tapers towards an edge, and a treated article.

Metal articles may be susceptible to damage from external impacts and fatigue. For example, a metal blade or aerofoil for a gas turbine, may be susceptible to foreign object damage (FOD) or fatigue, which may promote crack growth. A metal article may be particularly susceptible to crack growth from an edge.

### BRIEF SUMMARY

It is known to treat a region of an article to generate compressive residual stress to inhibit crack growth. Previously considered treatments are not suitable for an edge of a tapered article as they may result in excessive deformation of the edge, and because tool access to the edge may not be practical.

According to a first aspect there is provided a method of treating a metal article which tapers towards an edge comprising applying a compressive force to a treatment region of the article to generate an edge region of compressive residual stress adjacent the edge; wherein the treatment region is spaced apart from the edge region by an intermediate region.

The intermediate region may be part of an untreated region including both the intermediate region and the edge region. In other words, the treatment region is treated by the application of the compressive force, whereas the compressive force is not applied in the intermediate region and the edge region such that they are untreated. The intermediate region may therefore be referred to as an intermediate untreated region. The intermediate region and the edge region may be subject to other treatments (such as heat treatments and conventional surface finishing), but may not be treated by the application of compressive force to generate compressive residual stress in the edge region.

Applying the compressive force to the treatment region may generate a region of tensile residual stress in the intermediate region between the treatment region and the edge region. It will be appreciated that the tensile residual stress may be generated in a sub-region of the intermediate region. In other words, the region of tensile residual stress may be a sub-region of the intermediate region.

The treatment region may be spaced apart from the edge by at least 2.5 mm along a direction perpendicular to the edge. In other words, a boundary between the intermediate region and the treatment region may be separated from the edge by at least 2.5 mm along a direction perpendicular to the edge (i.e. the untreated region may extend at least 2.5 mm away from the edge along a direction perpendicular to the edge).

The article may have opposing surfaces which taper towards the edge. A separation between the surfaces may define a thickness of the article. The maximum thickness may vary along the edge, and may be the maximum thickness of the article along a direction perpendicular to the edge.

When the article comprises an aerofoil having a camber line, the maximum thickness in a respective chord-wise section of the aerofoil may be a maximum distance between opposing surfaces perpendicular to the camber line. The chord-wise section of the aerofoil may correspond to a portion of the edge and may therefore vary along the edge.

The method may comprising deep rolling to apply the compressive force. The method may comprise shot peening to apply the compressive force.

Applying the compressive force (i.e. by deep cold rolling) may comprise moving a roller element along a movement path having a plurality of path sections traversing back and forth over the treatment region along a principal direction substantially perpendicular to the edge. When the article comprises an aerofoil, the principal direction may be a chord-wise direction or may be substantially parallel with a chord of the aerofoil.

At each point along the movement path there may be a respective contact area over which the roller element contacts the treatment region. The compressive force may be applied so that each path section of the movement path has a contact pathway defined by the contact areas along the respective path section, which contact pathway overlaps with a contact pathway of an adjacent path section.

The compressive force may be applied so that a width of the contact pathway is substantially equal to twice the separation between adjacent path sections. Accordingly, each portion of the treatment region between adjacent path sections may be rolled twice. The separation between the adjacent path sections may be the separation between the centrelines of the respective path sections.

The article may comprise opposing surfaces which taper towards the edge. Compressive force may be applied simultaneously to corresponding opposing treatment regions. For example, roller (axially-extending) or ball (spherical) elements may be coupled to a calliper tool extending around the article and configured to compress the article between the elements.

The article may comprise an aerofoil defining the edge. The edge may be a leading edge of the aerofoil. Accordingly, the edge region of compressive stress may be generated adjacent the leading edge. Additionally or alternatively, an edge region of compressive stress may be generated adjacent a trailing edge of the aerofoil by treatment of a corresponding treatment region spaced apart from the trailing edge by a corresponding intermediate region.

The article may be an element for forming the leading edge of a composite fan blade having a composite body.

According to a second aspect there is provided a metal article which tapers towards an edge, the article comprising: a treated region of compressive residual stress; and an edge region of compressive residual stress adjacent the edge; wherein the treatment region is spaced apart from the edge region by an intermediate region.

The intermediate region may comprise a region of tensile residual stress.

The treated region may be spaced apart from the edge by at least 2.5 mm along a direction perpendicular to the edge.

The article may comprise an aerofoil defining the edge. The edge may be a leading edge of the aerofoil. The article may be selected from the group consisting of a compressor blade, turbine blade, fan blade, propeller blade.

The article may be an element for forming the leading edge or trailing edge of a composite fan blade having a composite body.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

The disclosure will now be described with reference to the accompanying drawings, in which:

FIG. 1 schematically shows a compressor blade for a gas turbine;

FIG. 2 schematically shows a portion of a surface of a compressor blade treated according to a previously considered treatment method;

FIG. 3 schematically shows a portion of a surface of a compressor blade treated according to the disclosure;

FIG. 4 schematically shows a distorted scale view of a large-aspect ratio portion of the compressor blade of FIG. 3;

FIG. 5 schematically shows an apparatus for treating the compressor blade of FIG. 1;

FIG. 6 schematically shows a cross-sectional view of the treated compressor blade of FIG. 3 depicting regions of compressive and tensile stress;

FIG. 7 schematically shows a treatment pathway for treating the compressor blade of FIG. 1 using the apparatus of FIG. 5; and

FIG. 8 schematically shows a composite fan blade having leading edge and trailing edge metalwork.

### DETAILED DESCRIPTION

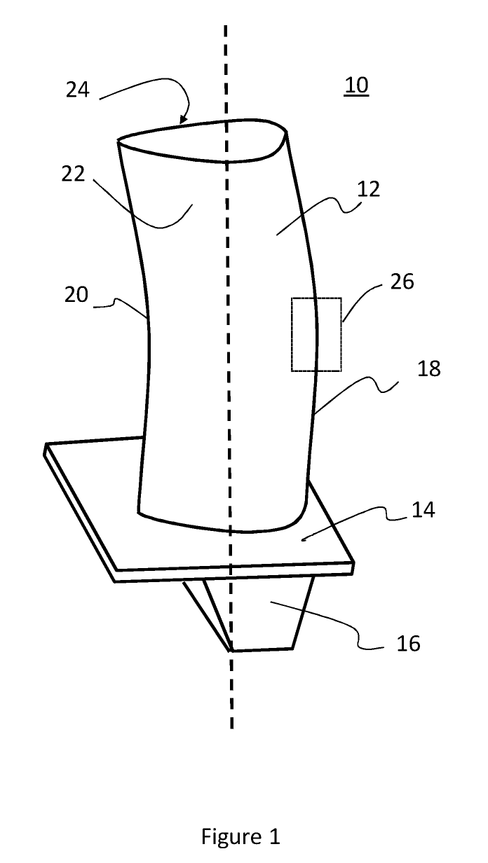

FIG. 1 shows a compressor blade 10 comprising an aerofoil portion 12, a platform 14 and a fir tree connector 16. The fir tree connector 16 is configured to slot into a disc of a gas turbine engine so that the aerofoil portion 12 extends substantially radially with respect to a rotational axis of the engine, and the platform 14 extends circumferentially and axially. The compressor blade 10 has a leading edge 18 and a trailing edge 20. The compressor blade 10 has a chord-wise direction extending from the leading edge to the trailing edge which is perpendicular to the radial or span-wise direction of the blade 10. In this example, the chord (i.e. the separation distance between the leading edge 18 and the trailing edge 20 along the chord-wise direction) varies along the span of the blade 10.

In this example, the compressor blade 10 is symmetrical, but other example blades may by non-symmetrical. The compressor blade has opposing aerodynamic surfaces 22, 24 extending between the leading edge 18 and trailing edge 20. The surfaces 22, 24 taper towards each of the leading edge 18 and the trailing edge 20 respectively.

In the following description, the terms leading edge and trailing edge are intended to take the standard meaning in the art. In particular, the leading edge is considered to be the foremost part of an aerofoil, whereas the trailing edge is the rearmost part. In this example, the leading edge 18 and trailing edge 20 are the forward and rear edges of the aerofoil to which the respective surfaces 18, 20 taper (i.e. the thinnest part towards the respective edge region along a direction perpendicular to the camber line of the aerofoil).

In this example, the compressor blade is an integral body comprising a titanium alloy, such as Ti-6Al-4V, but in other examples, a blade may comprise any other suitable material, such as nickel-based alloys including Inconel® 718, Udimet 718 and RR1000, and titanium-based alloys such as Ti6246.

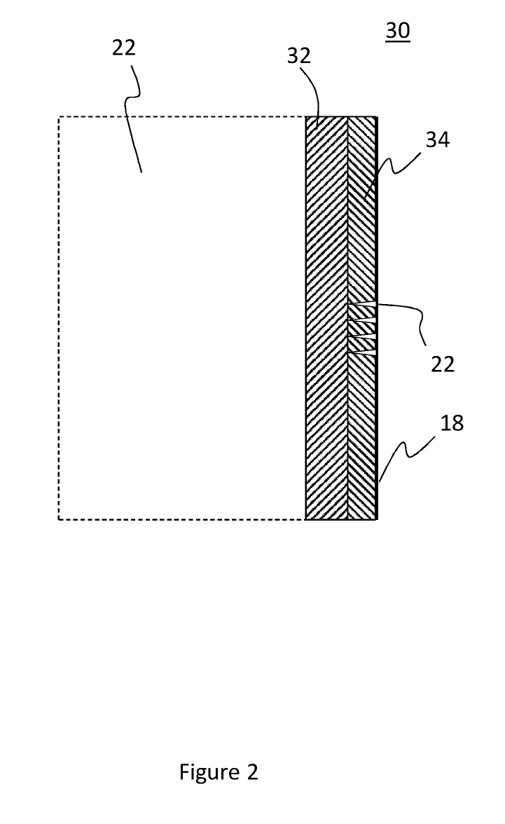

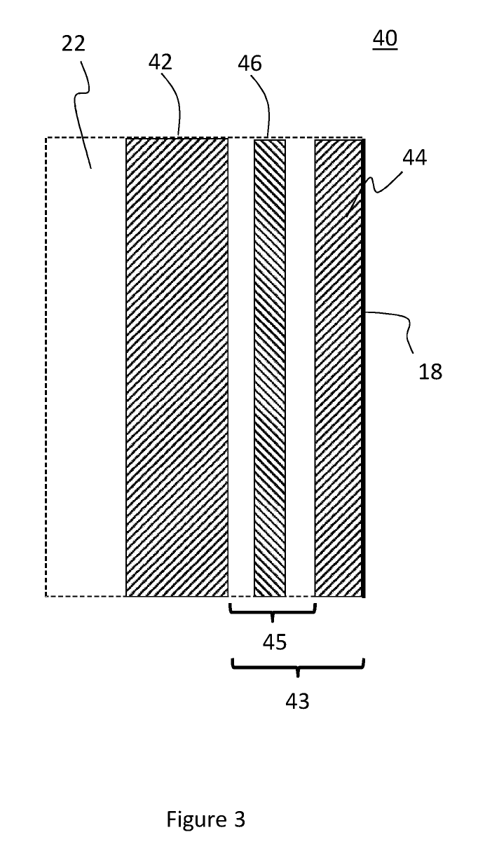

FIG. 1 shows a view window 26 corresponding to a sub-region of the leading edge 18 and the adjacent aerodynamic surface 22 of the example compressor blade 10. FIGS. 2 and 3 show sub-regions of example compressor blades 30, 40, corresponding to the view window 26 of FIG. 1.

FIG. 2 shows a sub-region of an example compressor blade 30 as described above with respect to FIG. 1 and treated according to a previously considered method, as will be described in detail below.

As shown in FIG. 2, there is a treatment region 32 extending substantially parallel to and spaced apart from the leading edge 18 of the blade. The treatment region 32 is treated to plastically deform the surface 22 of the blade with the effect of generating compressive residual stress within the treatment region 32. The treatment region 32 is spaced apart from the leading edge 18 to avoid inadvertent plastic deformation of the blade 30 in an untreated region immediately adjacent the leading edge 18. The region adjacent the leading edge may be both inherently thin owing to the tapering geometry, and susceptible to changes in aerodynamic performance if the geometry is altered.

A further limitation in treating this region relates to tool access to the region adjacent the leading edge 18. One technique of plastically deforming a surface is by the application of opposing rollers or burnishing balls to the surface. It will be appreciated that such rollers or balls engage a surface at a tangent to the surface. Owing to the curvature in the tapering region towards an edge, such rollers or balls contact each other before reaching the extreme edge, thereby limiting tool access to a region adjacent such an edge. In previously considered methods, the inaccessible region may extend approximately 0.3 mm away from the edge.

Treatment of the treatment region 32 generates tensile residual stress in a tension region 34 extending from the leading edge 18 to the treatment region 32.

As shown in FIG. 2, cracks 36 may form in the leading edge 18 and propagate chord-wise away from the leading edge through the tension region 34. However, crack growth is inhibited at the treatment region 32 owing to the compressive residual stress in the treatment region 32. In such methods, the treatment region 32 is disposed as close as possible to the leading edge 18 (for example, in view of tool access and undesirable deformation of the article) in order to limit the extent of crack growth. Nevertheless, the region adjacent the leading edge 18 remains under tensile residual stress.

FIG. 3 shows a sub-region of an example compressor blade 40 as described above with respect to FIG. 1 and treated according to a method according to the disclosure, as will be described in detail below. The sub-region corresponds to the window 26 of FIG. 1.

A treatment region 42 spaced apart from the leading edge 18 is treated to plastically deform the aerodynamic surface 22 in the treatment region 42, thereby generating compressive residual stress in the treatment region 42. In this example, compressive force is applied to the treatment region 42 by deep cold rolling, for example with a burnishing ball as will be described in detail below, although other suitable techniques may be used. The treatment region 42 is spaced apart from the leading edge 18 along a direction perpendicular to the leading edge 18.

An untreated region 43 extends from the leading edge 18 to the treatment region 42 along a direction substantially perpendicular to the edge. Unlike the treatment region 42, the untreated region 43 is not treated with compressive force to generate compressive residual stress within the same region.

The application of compressive force in the treatment region 42 of the tapering metal article results in the generation of a further region of compressive residual stress adjacent the leading edge 18, which region is referred to herein as the edge region 44. The edge region 44 of compressive residual stress is separated from the treatment region 42 by an intermediate region 45.

In this example, the application of compressive force in the treatment region 42 further results in the generation of a tensile region 46 (i.e. a region of tensile residual stress) within the intermediate region 45 that separates the edge region 44 and the treatment region 42.

Accordingly, compressive residual stress is generated in the edge region 44 adjacent the leading edge 18 without the direct application of compressive force to plastically deform the edge region. In contrast, the applicant has determined that, in a tapering metal article, compressive residual stress can be generated in an edge region 44 adjacent an edge 18 by the application of compressive force in a treatment region 42 separated from the edge region by an intermediate region 45. In this example, the intermediate region 45 (like the edge region 44) is untreated, and contains a tensile region 46 of tensile residual stress.

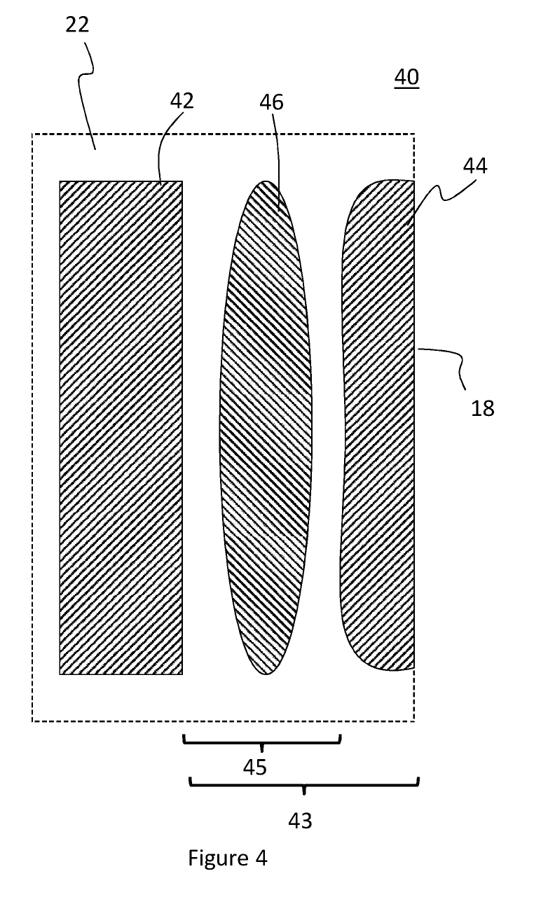

FIG. 4 shows a further partial view of the example compressor blade 40 of FIG. 3. FIG. 4 shows a distorted scale view depicting the full span-wise extent of the aerodynamic surface 22 but only a limited chord-wise extent of the surface 22 extending from the leading edge 18. As shown in FIG. 4, the shape of the tensile region 46 and edge region 44 may not be rectilinear. In this example, the edge region 44 of compressive residual stress has a span-wise border offset from the leading edge which curves towards the leading edge 18 over a central span-wise region of the blade. In this example, the tensile region 46 is substantially elliptical, having its greatest chord-wise extent over a substantially central span-wise region of the blade. As shown in FIG. 4, both the tensile region 46 and the edge region 44 have a span-wise extent which substantially corresponds to the span-wise extent of the treatment region 42. In this example, the treatment region 42 is substantially rectilinear.

It will be appreciated that in other examples the particular shapes of the edge region 44 of compressive residual stress and the tensile region 46 may be different; for example such shapes may depend on both the shape of the treatment region 42 and the compressive force treatment applied to it, and the geometry of the tapering blade.

In some examples, there may be a region of tensile residual stress adjacent the edge region 44 with respect to the span-wise direction and adjacent the leading edge 18. There may be two such regions at each span-wise end of the edge region 44.

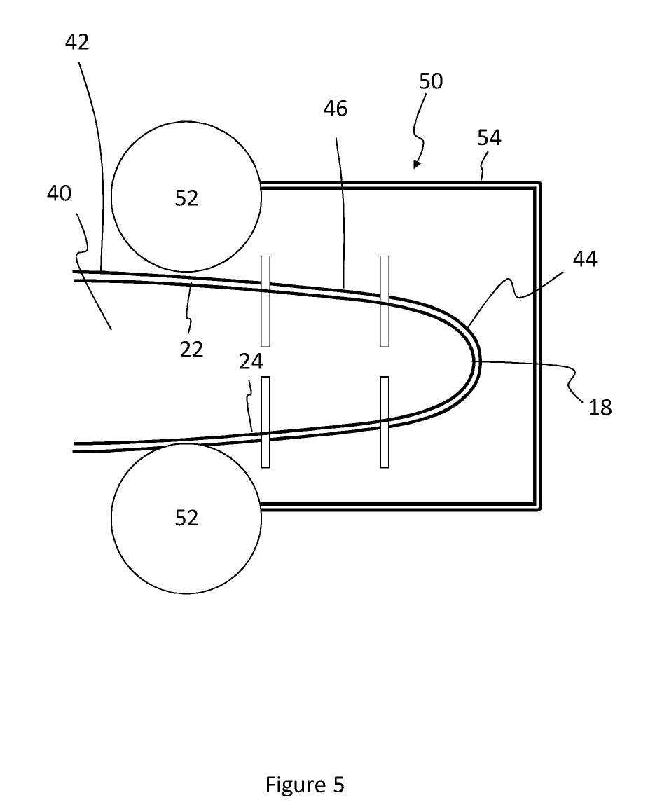

FIG. 5 shows a further partial view of the compressor blade 40 of FIGS. 3 and 4. FIG. 5 shows a partial chord-wise cross-sectional view of a portion of the compressor blade 40 showing opposing aerodynamic surfaces 22, 24 tapering towards the leading edge 18. It will be appreciated that the opposing surfaces 22, 24 taper in a similar manner towards the trailing edge 20.

FIG. 5 schematically shows the treatment region 42, tensile region 46 and edge regions 44 as overlaid lines on the respective surfaces 22. As can be seen from FIG. 5, the edge region 44 is adjacent to and extends through the leading edge 18 onto the opposing surface 24, such that over a principal span-wise extent of the compressor blade 40, the leading edge 18 lies within the edge region 44 of compressive stress. A principle span-wise extent may be a significant portion of the span, such as at least 20%, at least 50%, or at least 70% of the span of the edge.

In this example, the treatment region 42 and the untreated region are substantially mirrored on opposing surfaces 22, 24 of the blade. As shown in FIG. 5, there are opposing tensile regions 46 and treatment regions 42.

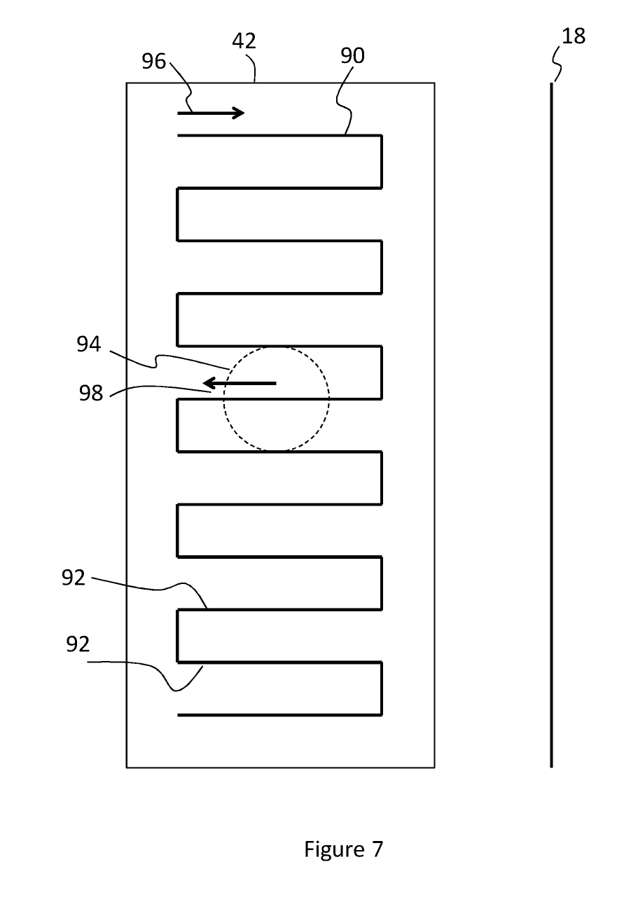

FIG. 5 further shows an example apparatus 50 for applying compressive force to the treatment regions 42 on opposing surfaces 22, 24 of the blade 40. In this example, the apparatus 50 comprises a pair of burnishing balls 52 mounted on a moveable calliper arm configured to press the burnishing balls 52 towards each other and against the blade 40 to apply compressive force to the treatment region, as will be described in detail below with respect to FIG. 7.

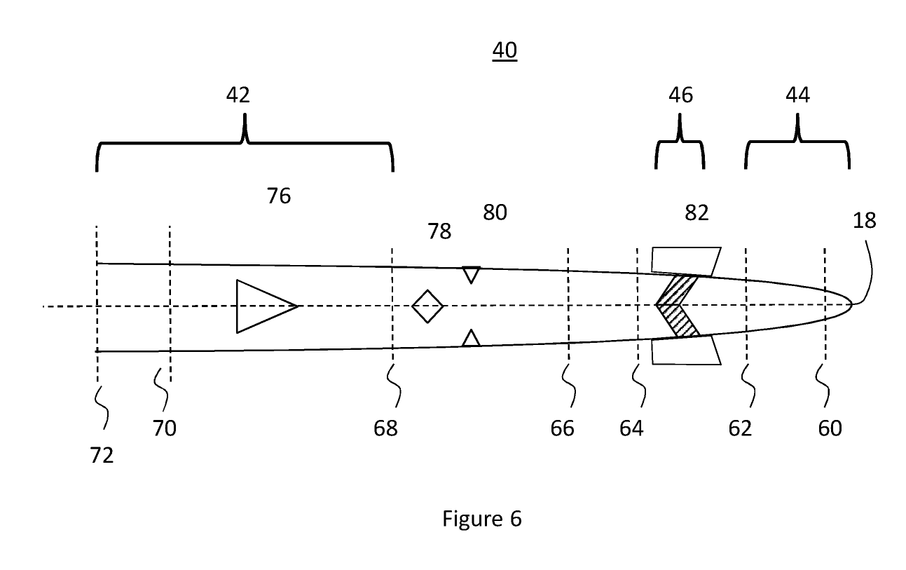

FIG. 6 shows an example plot of regions of residual stress within the blade 40 described above with respect to FIGS. 3-5. As described above, the applicant has determined that the application of compressive force to a treatment area of a tapering article away from a respective edge generates a pattern or field of residual stress in the article. As described above with respect to FIGS. 3-5, an example pattern includes a compressive residual stress in the treatment region 42, a tensile region 46 between the treatment region 42 and the edge 18, and an edge region 44 of compressive stress adjacent (and extending over) the edge 18. In other words, in the example pattern there is a region of tensile residual stress separating the treatment region 42 (of compressive residual stress) and the edge region 44 of compressive residual stress.

Whilst FIGS. 3-5 depict the regions of tensile and compressive stress at the opposing surfaces 22, 24, FIG. 6 shows regions of compressive and residual stress along a representative chord-wise cross section of the blade tapering towards the leading edge 18. FIG. 6 shows a succession of chord-wise locations sequentially offset from the leading edge. In this example, the chord-wise extent of the representative portion of the blade is approximately 40 mm, and a region of approximately 10 mm is shown in FIG. 6. The average residual stress at each of the chord-wise locations 60-72 is shown in Table 1 below, in order of chord-wise separation from the leading edge and by reference to the reference numeral (or “location ID”) used for the respective location in FIG. 6. The residual stress values shown in Table 1 relate to the average residual stress through the thickness of the blade 40 at the respective chord-wise location.

TABLE 1

| | Separation from | Residual Stress (MPa) |
|---|---|---|
| Location ID | Leading Edge (mm) | >0 Tensile; <0 Compressive |
| 60 | 0.5 | −300 |
| 62 | 1.5 | −150 |
| 64 | 2.5 | 0 |
| 66 | 3.5 | −150 |
| 68 | 5.5 | −600 |
| 70 | 8.0 | 300 |
| 72 | 10.0 | 450 |

Further residual stress values corresponding to selected zones or regions in the cross-section of FIG. 6 are shown in Table 2 below, together with the respective separation from the leading edge 18. The magnitude of the compressive stress in the selected zones of Table 2 is generally greater than the average values reported in Table 1, indicating the three-dimensional nature of the residual stress pattern imparted in the blade 40 owing to the application of compressive force in the treatment region 42.

TABLE 2

| | Separation from | Residual Stress (MPa) |
|---|---|---|
| Location ID | Leading Edge (mm) | >0 Tensile; <0 Compressive |
| 76 | 7.5 | −1100 |
| 78 | 5.0 | −900 |
| 80 | 4.5 | −900 |
| 82 | 2.0 | >0 |

As shown in FIG. 6, the chord-wise region between location IDs 72-68 corresponds to the treatment region 42, whereas the region between chord-wise locations 62 and the leading edge 18 corresponds to the edge region 44.

In some examples, the residual stress value may be directional. In this example, the residual stress values and relative definitions referred to in the above description relate to the residual stress along the span-wise axis of the blade. The applicant has found that it may be beneficial to maximise compressive residual stress along a direction substantially parallel with a respective edge (in this example, the span-wise direction) to resist crack opening.

In this example, residual stress values are obtained by finite element analysis (FEA) and may be calibrated by empirical testing, for example using digital image correlation and/or focused ion beam analysis, as is known in the art.

The particular values described above relate to an example compressor blade 40 having a symmetrical elliptical profile having a chord-wise extent of approximately 40 mm, a maximum thickness of 2 mm, and a span-wise extent of 50 mm. In this example, the treatment region has a span-wise extent of approximately 10 mm and a chord-wise extent of approximately 5 mm. The chord-wise separation between the leading edge and the centre of the treatment region is approximately 5.0 mm (between 2.5 mm and 7.5 mm from the tip, in this example). The edge region of compressive residual stress has a chord-wise extent of approximately 1.5 mm. The region of tensile residual stress is contiguous with the edge region and extends towards the treatment region.

However, it will be appreciated that the disclosure applies to blades and metal articles of other geometries which taper towards an edge.

In particular, in other examples the separation (or offset distance) between the treatment region 42 and the leading edge 18 may be greater or less. For example, the chord-wise separation distance between the leading edge 18 and the treatment region may be at least 2.5 mm, for example 5 mm, 7.5 mm or 10 mm. Geometric parameters, such as at least the span, chord, thickness shape and material may vary between example articles to which the treatment method can be applied.

A particular method of applying compressive force to the treatment region 42 will now be described with respect to FIG. 7. FIG. 7 shows the treatment region 42 of the example compressor blade 40 described above with respect to FIGS. 3-6, offset in the chord-wise direction relative the leading edge 18.

FIG. 7 schematically shows a simplified movement path 90 for a burnishing ball for applying compressive force to the treatment region 42 by deep cold rolling. The movement path 90 defines the path of movement of a central contact point of the burnishing ball over the treatment region. As shown in FIG. 7, the movement path comprises a plurality of path sections 92 that traverse back and forth over the treatment region 42 along a chord-wise axis, alternately towards and away from the leading edge 18. Arrow 96 indicates initial movement of the burnishing ball along the movement path 90 in a chord-wise direction towards the leading edge 18. Successive path sections 92 are connected by span-wise sections. The applicant has determined that movement of the burnishing ball along a principal axis substantially perpendicular to the span may maximise residual stress along the span-wise direction (where the principle direction corresponds to an axis which is parallel to the longer path sections, rather than the shorter interconnecting sections).

As will be appreciated, the burnishing ball has a contact area (rather than merely a contact point along the movement path 90) over which it contacts the surface 22 of the article within the treatment region 42 to plastically deform it. The contact area may depend on the force applied, material properties of the burnishing ball and the article, and may be determined using numerical simulation, for example by static or dynamic FEA.

FIG. 7 shows a circular contact area 94 of the burnishing ball centred on the movement path, at a representative point along the movement path. In this example, the movement path and contact area are such that the radius of the contact area is substantially equal to the separation (i.e. the span-wise separation, in this example) between adjacent path sections 92. Accordingly, the burnishing ball traverses over the treatment area in an overlapping manner such that each portion of the treatment region between is compressively loaded by the ball twice. Movement of the burnishing ball results in a contact pathway corresponding to the cumulative respective contact areas of the burnishing ball at each point along the movement pathway. Accordingly, the portion of the contact pathway associated with each path section 92 overlaps a respective contact pathway associated with an adjacent path section 92. It will be appreciated that, in practice, the compressive force may be controlled based on a target contact area, or otherwise the movement path may be dynamically adjusted as the contact area varies.

An example burnishing ball may be between 5 and 15 mm in diameter, for example. An example compressive force loading through the burning ball may be between 30 and 60 MPa, for example. An example burnishing ball may comprise a high strength material, such as tungsten carbide.

In the context of a rotary machine such as a gas turbine, it will be appreciated that the span-wise axis may substantially correspond to a radial axis of the rotary machine (i.e. a radial axis extending orthogonally from an axis of rotation).

Although an example of the disclosure has been described with respect to a metal article which comprises an aerofoil, in particular a compressor blade, it will be appreciated that the disclosure applies equally to other aerofoils and indeed other metal components. For example, the disclosure may be embodied by any type of metal member or aerofoil, such as fan blades and turbine blades.

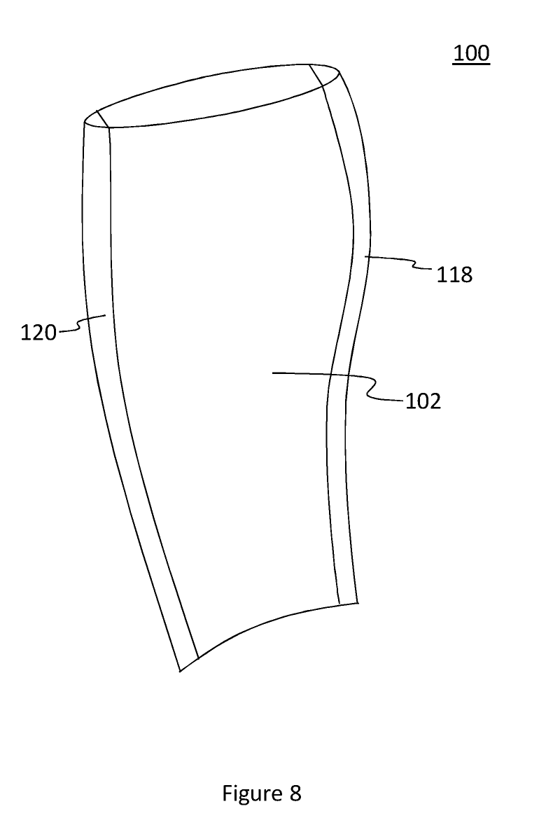

FIG. 8 shows an example composite fan blade 100 including an aerofoil body 102 comprising composite material (e.g. carbon fibre reinforced plastic) and protective edge metalwork. The edge metal work includes a leading edge member 118 and a trailing edge member 120 defining the leading edge and trailing edge of the fan blade 100 respectively. For example, the leading edge and trailing edge members 118, 120 may be bonded onto the aerofoil body 102. The leading edge and trailing edge members taper towards the leading edge and trailing edge respectively and may be treated by a treatment method as described above with respect to FIGS. 3-7. In further examples, the disclosure may apply to propeller blades, such as marine propellers. Yet further, the disclosure may apply to any metal article which tapers towards an edge and is susceptible to the generation of residual stress by the application of compressive force.

Whilst the expressions “chord-wise” and “span-wise” have been used in the above description in the context of a metal article comprising an aerofoil, in the context of non-aerofoil examples to which the disclosure applies, such terms can be interpreted as follows. In the context of a non-aerofoil component, references above to “chord-wise” can be interpreted to mean a longitudinal direction extending substantially perpendicular to the edge (i.e. the edge towards which the article tapers and where compressive stress is to be generated without direct application of force). For example, the longitudinal direction may extend from the edge to an opposing edge. In the context of a non-aerofoil component, references above to “span-wise” can be interpreted to mean a direction extending substantially parallel with the respective edge. These interpretations also apply to aerofoil components.

Whilst the disclosure has been described with respect to a particular treatment technique for the generation of residual stresses (deep cold rolling), it will be appreciated that other treatment techniques may be used, such as high intensity shot peening.

The terms “treated region” and “treatment region” may be used interchangeably with respect to an article that has been treated.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A method of treating a metallic aerofoil leading edge comprising applying a compressive force to a treatment region of the article to generate an edge region of compressive residual stress adjacent the edge; wherein the treatment region is spaced apart from the edge region by an intermediate region having a region of tensile residual stress generated by the application of the compressive force to the treatment region.

2. A method according to claim 1, wherein the treatment region is spaced apart from the edge by at least 2.5 mm along a direction perpendicular to the edge.

3. A method according to claim 1, comprising deep rolling to apply the compressive force.

4. A method according to claim 1, wherein applying the compressive force comprises moving a roller element along a movement path having a plurality of path sections traversing back and forth over the treatment region along a principal direction substantially perpendicular to the edge.

5. A method according to claim 4, wherein at each point along the movement path there is a respective contact area over which the roller element contacts the treatment region, and wherein the compressive force is applied so that each path section of the movement path has a contact pathway defined by the contact areas along the respective path section which overlaps with a respective contact pathway of an adjacent path section.

6. A method according to claim 5, wherein the compressive force is applied so that a width of the contact pathway is substantially equal to twice the separation between adjacent path sections.

7. A method according to claim 1, wherein the article comprises opposing surfaces which taper towards the edge, and wherein compressive force is applied simultaneously to corresponding opposing treatment regions.

8. A method according to claim 1, wherein the article is an element for forming the leading edge of a composite fan blade having a composite body.

9. A method of treating a metal article which tapers towards an edge comprising applying a compressive force to a treatment region of the article to generate an edge region of compressive residual stress adjacent the edge; wherein the treatment region is spaced apart from the edge region by an intermediate region having a region of tensile residual stress generated by the application of the compressive force to the treatment region.

10. A method of treating a metal article according to claim 9, wherein the treatment region is spaced apart from the edge by at least 2.5 mm along a direction perpendicular to the edge.

11. A method according to claim 10, wherein applying the compressive force comprises moving a roller element along a movement path having a plurality of path sections traversing back and forth over the treatment region along a principal direction substantially perpendicular to the edge.

12. A method according to claim 11, wherein at each point along the movement path there is a respective contact area over which the roller element contacts the treatment region, and wherein the compressive force is applied so that each path section of the movement path has a contact pathway defined by the contact areas along the respective path section which overlaps with a respective contact pathway of an adjacent path section and wherein the compressive force is applied so that a width of the contact pathway is substantially equal to twice the separation between adjacent path sections.

13. A method according to claim 12, wherein the article comprises opposing surfaces which taper towards the edge, and wherein compressive force is applied simultaneously to corresponding opposing treatment regions.

14. A metal article, the article comprising:
a treated region of compressive residual stress;
an edge region of compressive residual stress adjacent the edge;
wherein the treatment region is spaced apart from the edge region by an intermediate region that comprises a region of tensile residual stress.

15. An article according to claim 14, wherein the treated region is spaced apart from the edge by at least 2.5 mm along a direction perpendicular to the edge.

16. An article according to claim 14, wherein the article comprises an aerofoil defining the edge.

17. An article according to claim 16, wherein the edge is a leading edge of the aerofoil.

18. An article according to claim 16, wherein the article is selected from the group consisting of a compressor blade, turbine blade, fan blade, propeller blade.

19. An article according to claim 14, wherein the article is an element for forming the leading edge of a composite fan blade having a composite body.
